(19) United States
(12) Patent Application Publication
(10) Pub. No.: US 2005/0198162 A1
(43) Pub. Date: Sep. 8, 2005

(54) Method and system of collaborative browsing

(76) Inventors: Kirk Wayne Bauer JR., Atlanta, GA (US); James Gregory Dooley, Atlanta, GA (US); Nickolas Emmanuel Achille Downey, Atlanta, GA (US); Richard K. Hargett JR., Atlanta, GA (US); Jeffrey Lawson Jones, Atlanta, GA (US); William Gilmore Thomasson, Lawrenceville, GA (US); Stephen Lee Wong, Dunwoody, GA (US)

Correspondence Address: NEEDLE & ROSENBERG, P.C., SUITE 1000, 999 PEACHTREE STREET, ATLANTA, GA, 30309-3915, US

(21) Appl. No.: 10/932,827

(22) Filed: Sep. 2, 2004

Related U.S. Application Data
(62) Division of application No. 09/742,091, filed on Dec. 22, 2000.

(51) Int. Cl. G06F 15/16

(52) U.S. Cl. 709/206; 709/227

(57) ABSTRACT

A dynamic collaborative-browsing system enables client programs connected to a computer network to join and leave groups or sessions, to collaboratively browse together as a session, to communicate with other client programs in the session. Each client program in the session may act as a session leader, or may just follow a session leader as it browses network sites of the computer network. The system includes client programs, typically executing on client computers and server software, typically executing on one or more main servers. Network servers, such as Web servers, host a number of network sites each having a location or uniform resource locator (URL). The main server groups into server-defined cells. One or more client programs interact with the server software to cause the server to create a session, to cause the client program to connect to a network site, to notify the server software of the network site's location or URL, and to notify other client programs in the session of the network site's location or URL so that other client programs in the session become connected to the same network site. The server software facilitates the formation of client programs into sessions and allows the client programs to communicate, to connect to and view a same network site, and to perform other collaborative activities. The server software also groups sessions currently connected to network sites in a same cell, and notifies each session and the client programs of the sessions of all of the other sessions and client programs in the same cell. The server software also facilitates communication between the sessions and client programs connected to network sites in the same cell.

### BACKGROUND OF THE INVENTION

1. Field of the Invention

This invention relates to browsing. More particularly, it relates to a system and method of computer network browsing in which individual users can selectively identify, join, interact with, follow, lead, and leave one or more browsing communities.

2. Discussion of the Related Art

In recent years the Internet has become an information medium that is widely used for learning, communicating, advertising, entertaining, shopping, and interacting. The dramatic growth of the Internet has significantly impacted how information and knowledge is stored, searched, obtained, and communicated, and thus has changed how people share ideas. Indeed, some believe that the Internet is a major component of a new information revolution that will prove as significant as the industrial revolution.

One problem with efficiently utilizing the Internet, and closely related networks such as Intranets, is the sheer amount of information that is available. In the case of the Internet, that information is widely dispersed across many sites and Web pages. While information searching can be performed using a search engine to search the Internet using a particular query, another approach is to simply browse the Internet. When browsing, an operator jumps from a hyperlink on one Web page to another Web page, and then to the next, and so on. Such free form jumping from Web page to Web page can not only reveal sought after information it has become a popular pastime. However, one limitation of this pastime is that it is almost always performed in a solitary fashion.

While Internet searching and browsing have generally been successful, they have limitations. For example, Web searching often turns up such a large number of possible “hits” for a particular query that all of the sites cannot be visited. For example, it is not uncommon for a Web search to locate hundreds or thousands of Web pages in response to a single query. Furthermore, a given query can produce so much irrelevant information that the actual information being sought cannot be found. Thus, Web searching can not only take a lot of time, but it remains a solitary experience. This can be a major limitation when friends, co-workers, or others having similar interests and/or seek the same information. For example, dispersed family members may have trouble coordinating a family reunion because they cannot dynamically share information, such as airline travel times, seat availability, and hotel reservations.

Additionally, the value of the Internet as a learning tool is limited because a guide or a teacher cannot easily use the Internet dynamically. For example, a teacher may have a number of Web sites that he wants to take students to. Having all students on the same Web site either takes significant time or it simply doesn't get done. Compounding this problem is students who are not physically located together. As a related issue the value of the Internet as a research tool is somewhat limited because researchers cannot readily browse together, with each researcher leading sometimes and following other times.

Thus, it is obvious that the Internet, and related networks such as Intranets, are limited by a general inability of multiple users to dynamically and effectively work together as a group. Effectively working together as a group can involve an ability to browse as a group, an ability to dynamically link up to and then leave a group, an ability to follow a group leader, an ability to become a group leader, and an ability to communicate with other group members.

Furthermore, in some applications effectively working together involves more than individual human users. For example, in a classroom or in customer service it might be beneficial for users to automatically move together from one network location to another. Therefore, a group should be thought of as being comprised of client programs, not individuals.

Therefore, a system that enables client programs to dynamically join and leave groups, to collaboratively browse as a group, to follow or act as a group leader, and to communicate with other group members would be beneficial. Even more beneficial would be the ability to communicate with other group members by sending and receiving instant messages, by an ability to publicly and/or privately chat, and to send and receive files. Even more beneficial would be the ability to recognize when allied client programs are available for communication and collaborative browsing. Finally, since browsing requires a financial commitment, and as producing a revenue stream can be important, it would be beneficial for the system to enable advertisements or other announcements, and to enable customer service representatives to help users find information and complete transactions.

### SUMMARY OF THE INVENTION

The principles of the present invention provide for collaborative browsing. Various embodiments of the principles of the present invention can enable client programs to perform one, several, or all of the tasks of: dynamically joining and leaving sessions, and collaboratively browse as a session, following a group leader, acting as a group leader, communicating with other client programs, sharing files, receiving advertisements, and/or recognizing allied client programs. Thus, various disadvantages of the Internet and of other networks such as Intranets have been substantially reduced or eliminated.

A system according to the principles of the present invention systems includes a network having a plurality of network sites, such as the Internet, a plurality of client programs, and a main server executing server software. It should be understood that the main server as described herein may comprise a plurality of physically distinct hardware units together performing the server function(s). For example, the main server may comprise a plurality of processors and associated memory connected together on a communication bus and/or the Internet. The server software tracks the individual client programs on the network, the client programs in each session, and the sessions in each cell, with a cell being a network site or group of network sites that are serviced by the server software. Each client program, which may be an Internet browser having a special plug-in, interacts on the network and with the server software. In response to client program commands, the server software joins client programs into sessions. A session, which is a basic type of group, is comprised of a collection of client programs that can interact together. The server software tracks the sessions and, via the individual client programs, enables each client program in a session to dynamically interact with other client programs in that session. Dynamic interaction includes joining a session, leaving a session, collaboratively browsing as a group, and communicating with other session users. Communicating beneficially includes group chatting, sending private instant messages to other session members, or sharing files. A collaborative browsing session can follow a group leader from one network (Web) site to another site. Beneficially, each client program can act as a group (or session) leader, and multiple group leaders can exist within a group such that all client programs in a session may be group leaders.

Beneficially, unless disabled by an individual client program, the server software informs all client programs in all sessions about all of the other sessions on the same cell. Even more beneficially, the server software enables communication among all client programs located in a cell. Individual client programs or sessions in a cell can request permission to join another session. If permission is granted, the server software joins the client programs or sessions together. Furthermore, an individual client program in one session can relocate to or communicate with other client programs in other sessions in a cell. Cells tracked by the server software, all sessions in those cells, and all client programs in those sessions comprise a SimulWorld. Beneficially, an individual main server can handle multiple SimulWorlds. Alternatively or additionally, individual main servers or multiple main servers can link their SimulWorlds together via server software.

Beneficially, the presence of allied client programs on a main server is signaled to each client program. An allied client program is a pre-designated client program for which a notification is sent to a particular client program whenever it is connected to the network and is available for interaction. Typical allied client programs may include those initiated by friends, co-workers, and family member. Allied client programs can interact and can form new sessions. Furthermore, unless blocked by a client program, allied client programs can communicate together even when they are not in the same cell.

The server software interacts with each client program such that each client program can dynamically enter into and leave sessions, follow a session, lead a session, communicate with other session client programs and allied client programs, and become aware of other sessions in a cell. To this end, the server software receives and stores session data (URL information), client program information, client program preferences, and session data. The server software updates session data based upon actions of the individual client programs and updates session data to other sessions in a cell and to other allied client programs.

Each client program displays information from the server software. That information beneficially includes the other client programs in a session, allied client programs, and the other sessions in a cell. Furthermore, the client programs display other client programs in a session, allied client programs, and the other sessions in the current cell, and enable communication with the other session client programs, allied client programs, and the other sessions in the cell. Each client programs further enables preferences to be sent to the server software.

### BRIEF DESCRIPTION OF THE DRAWINGS

To better understand the principles of the present invention and to realize further features and advantages thereof, reference is now made to the following description taken in conjunction with the accompanying drawings, in which:

FIG. 1 illustrates an exemplary system having multiple client programs and multiple servers connected to a network, specifically the Internet, according to the principles of the present invention;

FIG. 2 illustrates multiple client programs in multiple sessions on a cell;

FIG. 3 illustrates a SimulWorld comprised of multiple cells, each having multiple sessions, with each session comprised of multiple client programs, and an allied client program; and

FIG. 4 illustrates an exemplary client program's screen view according to the principles of the present invention.

### DETAILED DESCRIPTION OF THE INVENTION

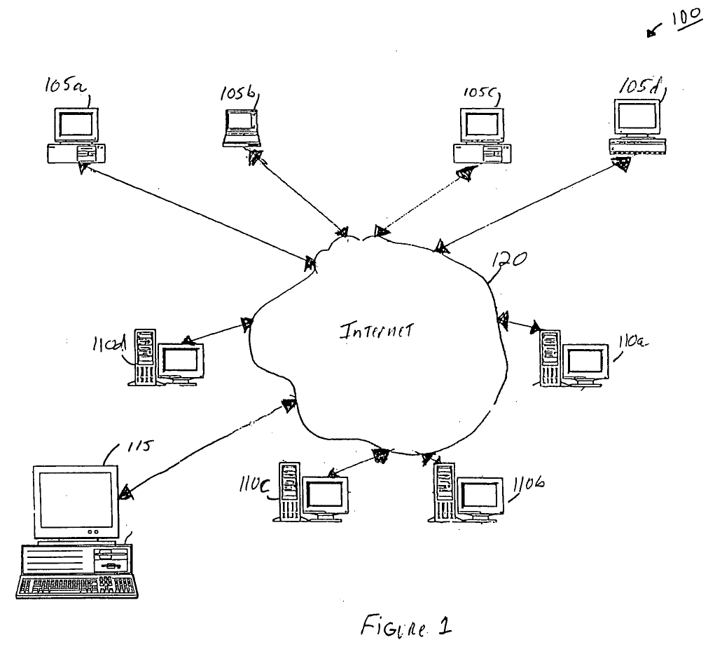

FIG. 1 illustrates an exemplary system 100 having multiple client program computers, the computers 105a-105d, and multiple network servers, the network servers 110a-110d, and a main server 115. The client program computers 105 and all of the network servers 110 are all bi-directionally connected to the Internet 120. The client program computers 105 and the network servers 110 are typically personal computers that are actually connected to the Internet 120 through a dedicated Internet port or through an Internet service provider (ISP). However, the client program computers 105 may also comprise personal digital assistants (PDAs), Web-equipped cellular telephones, Internet appliances, or other intelligent devices having a processor, memory, and data input/output means.

The term “client program computer” designates a remote entity that connects to the system 100. In practice a client program, which may or may not be installed and executing on an individual user's computer, logs onto the main server via server software. Significantly, that client program may or may not be controlled by a human operator. For example, the system 100 can run with an automated client program.

Typically, when connected to the Internet 120 a client program computer 105 runs under the control of a software browser, such as MICROSOFT® INTERNET EXPLORER®. While software browsers are complete applications, they are often designed to accept plug-ins: small code resources that run in the software browser. In FIG. 1 it is assumed that the client program computers 105a-105d are running under an Internet browser having a special plug-in that is in accord with the principles of the present invention. However, dedicated software programs and even special hardware can also be used.

To enter the system 100 a client program establishes a connection to the Internet 120 and sends information regarding the client program and/or the client program computer 105a to the main server 115. The server software that operates the main server 115 then verifies that the client program is authorized to use resources of the main server 115 to collaboratively browse. If authorized, then client program computer 105a is connected to the main server 115, otherwise the client program is denied access. If this is the first time that client program has attempted to connect to the main server 115, the server software establishes passwords and access protocols with the client program. That client program also supplies useful information to the server software. Specifically, the client program computer 105a sends the main server 115 the client program's Universal Resource Locator (URL). A URL is the current location code identifier of the client program computer 105a. Additional information that the main server 115 may receive from client program computer 105a is a list of allied client programs. An example of a list of allied client programs is a “friend's list.” Allied client programs are other client programs that a particular client program wants to be know when they are connected to the main server and are available for interaction with. A typical allied client program list might include client programs of co-workers, family members, research associates, and business partners.

Once a client program has entered the system 100 that client program is free to establish a connection with a network site that is maintained on a network server 110b. In interacting with the network, a client program navigates a hierarchy of Web pages maintained on the network server 110b. The pages are written or otherwise generated using HyperText Markup Language (HTML), JAVA®, or another suitable content development language that conveys text, images, sounds, actions, or other information to a user. A network server 110 therefore may contain many different Internet sites, each with many pages of information that can be navigated by the client program.

The server software has been programmed to recognize server-defined cells. A cell may be a Web site or a group of Web sites. For example, a company A might have five Internet Web sites, each with hundreds of Web pages. That company, all of its Web sites, and each of the Web pages could all be defined to form one cell. Another example of a cell might be a university having numerous colleges, laboratories, professors, instructors, and associated organizations. That university's Web resources could all be defined as one cell. Finally, top-level domains can be recognized by their URLs. The server software can identify and track those top-level domains and categorize each top-level domain as one cell. Significantly, the cells can be predefined or configured dynamically.

A cell may also be defined in terms of other resources available via the Internet 120. For example, a streaming audio file or a streaming video file that is accessible via the Internet 120 may be defined as a cell. Other Internet resources may similarly be defined as a single cell.

Each time a client program computer 105, for example the client program computer 105a, establishes a new network (Web) location, the client program sends the main server 115 the URL of the new network location. If the network location's URL is identified as belonging to a particular cell, the server software sends the client program computer 105a information (such as names) of the other client program in that cell. For example, if client program computer 105b is in a cell, and if client program computer 105a connects to that cell, then the server software informs the client program computer 105b that the client program computer 105a is in that cell. Similarly, the server software informs the client program computer 105a that the client program computer 105b is also in the cell. This is readily performed since the server software recognizes cells and tracks the locations of all of the client programs.

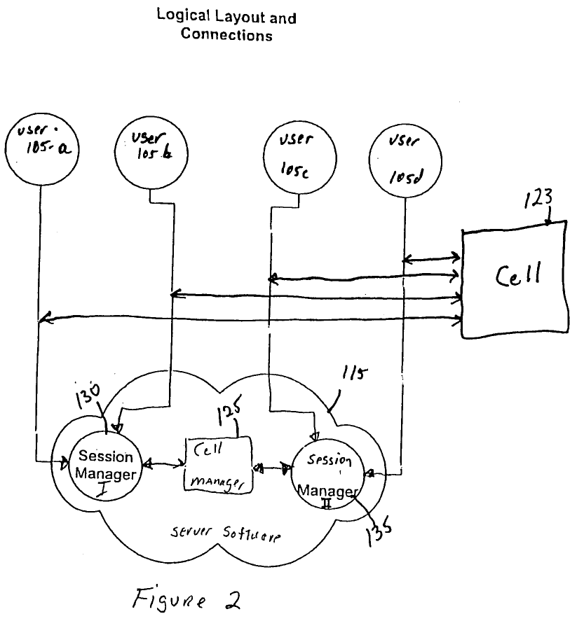

When multiple client program are in a cell, then the corresponding client programs have the option of joining a session. FIG. 2 helps illustrate this. As shown, the four client program computers 105a-105d are in cell 123. The server software of the main server 115 includes a cell manager 125 that identifies that the client program computers 105a-105d are in cell 123. As shown, the client programs of the client program computers 105a and 105b have decided to join a session. That session is controlled by a session manager 130. Likewise, the client programs of the client program computers 105c and 105d have decided to join another session, which is also controlled by the session manager 130. Conceptually, a client program that has not joined any other session is in its own session.

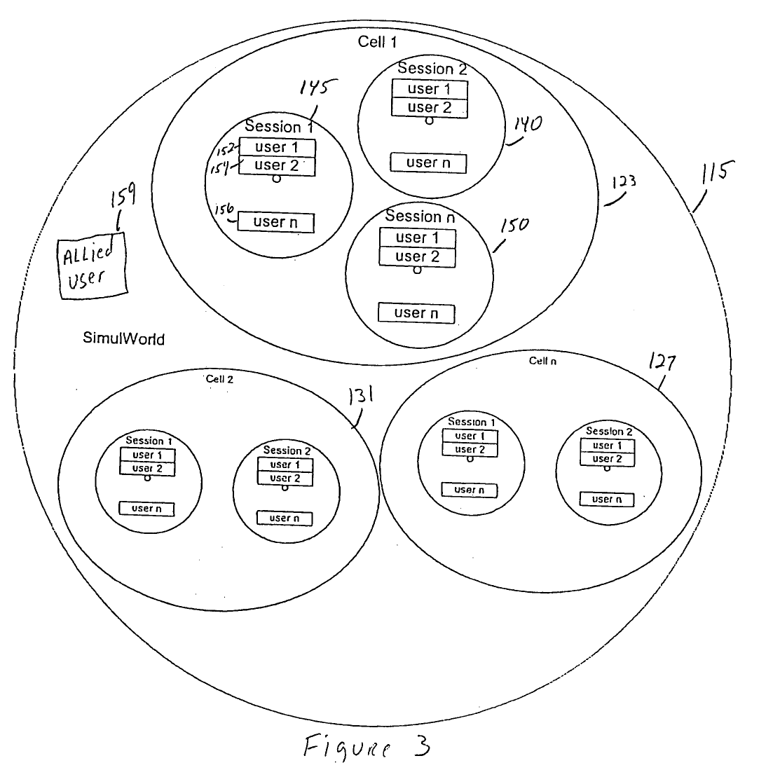

The server software can track many client programs in many cells and in many sessions. For example, FIG. 3 illustrates a main server 115 which tracks three cells—the cells 123, 127, and 131. Each cell has multiple sessions. For example, the cell 123 has sessions 140, 145, and 150. Furthermore, each session might include multiple client programs, for example the session 145 includes client programs 152-156. Furthermore, an allied client program 159 of one of the other client programs, say client program 152, is also connected to the main server 115. The sum of all of the cells represents a SimulWorld. Only properly authorized client programs can enter a SimulWorld. It should be understood that an individual main server could handle multiple SimulWorlds. Alternatively, the server software of a main server can link SimulWorlds together.

Joining a session enables that session's client programs to collaboratively browse. One of the session client programs acts as a guide that the others follow. A guide might be selected by the consent of the session client programs, or a guide might be selected by external factors, such as a client program being an instructor or other knowledge expert. If collaborative browsing is enabled by a session client program, when the guide's client program computer 105 moves the session to a new network location (Web page or other Internet resource or location) each enabled session client program is informed of the new location so that they can follow the guide. To accomplish this, the guide client program sends the new network location to the server software. In turn, the server software causes the main server 115 to send the guide's network location (URL) to each session client program computer 105. The client programs receives the new URL and cause their client program computer 105 to establish a connection at the new network location (URL). In this manner all session client program computers 105 are directed to the same location. If the new location is in a cell, the presence of the session is then transmitted to all of the other sessions and client programs that are also in that cell. Beneficially, the client program enables any session client program computer to act as a guide.

It should be understood that not only client programs can join a session, but also sessions themselves can merge. For example, in FIG. 2 the session comprised of the client program computers 105a and 105b could merge into a session comprised of the client program computers 105c through 105d.

Client programs in a session can communicate with other client programs in that session. Also, client programs in a cell can communicate with other client programs in that cell. This is possible because the server software receives messages from a session client program and then redirects that message to another session client program or client programs. Client programs in sessions in a cell can communicate to other client programs in other sessions in that same cell. Thus, client programs in sessions in the same cell can freely exchange information and do business together. For example, client programs in the same session can chat together as a group, send private messages to other group members, and exchange files. Furthermore, all client programs in a cell can similarly communicate. This is possible because the server software directs the main server 115 to receive messages from client programs in a session and then redirects those messages to other client programs in that session.

In addition to each client program being aware of other client programs in his session and aware of other client programs and sessions in its cell, a client program can selectively become aware of allied client programs whose client program computers 105 are connected to the main server 115. For example, referring to FIG. 3, each time a client program, say the client program 152, connects its client program computer 105 to the main server 115, the server software searches the client program's 152 allied client program list to identify any allied client programs, say the allied client program 159, whose computer(s) are also connected to the main server 115. The identities of the allied client programs are then sent by the main server 115 to the client program computer 105 of client program 152. The client program 152 can then display the identity of the allied client programs. The client program 152 and the allied client program 159 can then communicate with each other through the main server 115. The allied client program 159 does not have to be in the same session or on the same cell as the client program 152. This is readily performed as the server software is aware of the client programs, the allied client programs on each client program's allied user list, and the cell locations of the allied client programs.

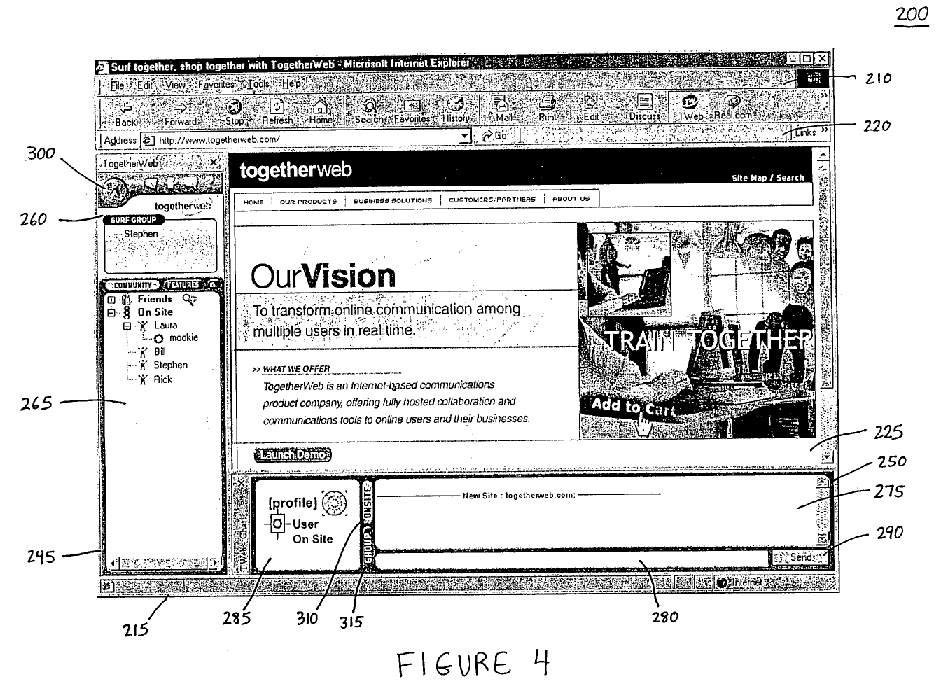

The client program controls how it implements the principles of the present invention. Various software embodiments may implement all of the features that are discussed herein, some of those features, or other features. However, FIG. 4 illustrates a typical client program's screen view 200 as displayed on a client program computer 105.

To assist the understanding of the description which follows, a particular client program whose screen is being referred to is hereinafter referred to as the current user. Other client programs will be referred to as other users.

The screen view 200 includes typical window taskbars and system information bars 210 and 215. Additionally, the screen view 200 includes typical Internet browser windows, such as an address bar 220 and site window 225. Other operating systems and browsers, or specifically dedicated software, may have other windows and bars. The screen view 200 also includes a link window 245 and a communication window 250.

The link window 245 includes a session pane 260 that displays the names of other session users. Those names are sent to each of the session users by the main server 115 so that they can be displayed. The link window 245 also includes a community pane 265 that displays the names of other users in the same cell as the current user. Additionally, the names the current user's allied users are also shown.

The communication window 250 includes a chat pane 275, a message pane 280, and an advertisement pane 285. The chat pane 275 provides a listing of communications that are available to the current user. Such communications might be from other session users, from other users in the current user's cell, or from allied users of the current user. The message pane 280 is used to form comments prior to the current user sending those comments. After a comment is complete, the current user clicks a send button 290 that transmits the comment to the main server 115, which then transmits the comment to desired other users. Again, those users might be other session users, other users in the current user's cell, or the current user's allied users.

The advertisement pane 285 displays advertisements sent by the main server 115 to the current user. As information about the current user is available on the main server 115, that advertisement may be specifically targeted to that current user. Another approach is to display an advertisement that is specifically related to the current cell of the current user. This not only enables a source of revenue to the operator of the main server 115, but provides the current user with information that is more likely to be useful to him than random advertisements might be.

The client program enables the current user to customize his experience on the system 100. For example, referring now to FIGS. 2 and 4, assume that the current user wants to follow another session user, say the current user of the user computer 105a wants to follow a session user of user computer 105b. In that case, the current user right-clicks the name of the user of user computer 105b in the session pane 260. A selection window then pops up on the current user's computer display screen and the current user double-click selects Follow User. This in turn transmits a message from the current user's client program computer 105a to the main server 115 indicating that the client program computer 105a should now follow the user computer 105b. By means of the main server 115, the client program computer 105a then follows the client program computer 105b as the user of the client program computer 105b browses the Web. The names of other users whose client program computers 105 are following the client program computer 105b are also shown in the session pane 260. At this time an icon 300 changes to a binocular to indicate that the current user is in a Follow Mode. To stop following the client program computer 105b, and thus enable independent browsing, the current user right-clicks the name of the user of the client program computer 105b and then selects Stop Following. Alternatively the current user could also right-click the icon 300 and then choose Stop Following. The icon 300 then changes from a binocular to a surfer, indicating that the current user in a solo browse mode.

The client program also enables the current user to invite other users to join a session. For example, the current user might right click his mouse and then choose an Invite feature on a selection window that pops up. The client program then places the current user's name in a simple invite window. Then, the current user enters a personal message, selects a number of allied users or other users in his session or on his current cell, right-clicks and selects Invite Friends. A message is then sent by the main server 115 to the client program computers 105 of the selected users inviting them to join the current user's session.

Additionally, the client program enables the current user to add allied users to his allied user list by right clicking and then selecting Add Friend. The allied user list of the current user is then displayed. The current user then updates his allied user list and sends that information to the main server 115, which updates the current user's allied user list which is stored therein. Alternatively, the current user can search for an allied user by searching for their names on the current cell or from an email message. Once an allied user is found, the current user then highlights the desired allied user, right clicks, and selects Add Friend. Allied users can be removed from an allied user list by right clicking to display the allied user list, finding the allied user to be removed, and then choosing Remove Friend.

The client program also enables the current user to update his profile. This allows the current user to provide the main server 115 with his interests and other relevant information. To perform this function, the current user right-clicks and then chooses View Profile. A pop-up window then opens with the user's profile displayed. The user's profile can then be updated and sent to the main server 115.

The client program also enables chatting. The current user can send messages by composing the message, and then clicking the send tab 290. This causes the client program computer 105 to send the message which is displayed in the message pane 280 to the main server 115, which then sends the message to other session users, to other user's in the cell, or to allied users. Alternatively, the current user can send his message to his current session only by first clicking a Group tab 315. Messages in the message pane are then sent to other users in the same session when the Send tab 290 is clicked.

While collaboratively browsing and chatting are generally useful, at times the current user may find it desirable to prevent others from following, chatting or collaboratively browsing. The client program enables this. For example, the current user can select a user's name in the link window 245 and then right click and select Block User on a selection window that appears. That user is then blocked and thus prevented from following, chatting or collaboratively browsing with the current user. However, a blocked user can be unblocked by the current user selecting a blocked user name, right-clicking and then choosing Unblock User. This removes the block.

While the ability to block individual users is beneficial, at other times the current user might want to prevent all other users from knowing his current cell and to prevent other users from chatting and collaboratively browsing. The client program enables this by providing the user the ability to right-click the icon 300, select the Private Mode on a selection screen that appears, and then choose Private. The icon 300 then changes to a lock and users cannot see the current user's cell or chat with the current user. The private mode can be removed by right-clicking the icon 300 and then choosing Public Surf. The icon 300 then changes to a surfer and the current user is no longer in Private Mode.

Another useful feature the client program provides the current user is the ability to obtain a list of popular sites from the main server 115. This is enabled by clicking a Top Sites icon 317. The main server 115 then sends a list of the most popular cells to the current user's client program computer 105. Additionally, the listing of the other users in the current cell can be enabled or removed by clicking a Community icon 320, and then clicking on either a plus sign that appears to enable the listing, or a negative sign that appears to remove the listing.

The principles of the present invention are applicable to many different hardware and software components. Systems could be configured to operate on various types of hardware, including APPLE® personal computers, INTEL®-based personal computer, mainframes, and miniframes. Software components could be configured to operate as stand-alone programs or as plug-in to various Internet browser programs.

Additionally, while the foregoing has described only one main server 115, in some networks there may be more than one main server 115. For example, the United States could have a main server 115a, England a main server 115b, and Germany a main server 115c. Then, when a particular user's client program computer 105 connects to the Internet 120, each main server 115 might be contacted. However, according to the user's location or URL, only the appropriate main server 115 will service that user. One advantage of a system having distributed servers is the possibility of increased speed.

As only qualified users can enter a SimulWorld, the client program beneficially enables a user to enter the SimulWorld from any client program computer 105. For example, a user might enter a SimulWorld by default whenever the user opens his Web browser. Alternatively a user might enter an access code that is recognized by a main server 115 to enter a particular SimulWorld. Additionally, one or more main servers 115 can merge SimulWorlds.

While the foregoing has generally discussed using the principles of the present invention in an Internet application, those principles are fully applicable to other networks. For example, the principles of the present invention can find use in local area networks, and Intranet systems.

Although the present invention has been described in relation to a particular system, a plethora of changes, substitutions, variations, alterations, transformations, and modifications may be suggested to one skilled in the art, and it is intended that the present invention encompass such changes, substitutions, variations, alterations, transformations, and modifications as fall within the spirit and scope of the appended claims.

1-20. (canceled)

21. A main server holding a SimulWorld, comprising
a session manager for receiving commands that selectively join a plurality of users into a session;
a cell manager for forming a plurality of network locations into a server-defined cell;
wherein the main server sends information to a first user regarding properties of the session;
wherein the main server sends information to the first user regarding other sessions in the cell; and
wherein the main server sends updated network location information of the session to the first user when the session changes its network location.

22. A main server according to claim 21, wherein the main server receives message information from the first user and selectively sends that message information to the other users in the session.

23. A main server according to claim 21, wherein the main server receives message information from the first user and selectively sends that message information to other users in the other sessions in the cell.

24. A main server according to claim 21, wherein the main server sends information to a first user regarding an allied user.

25. A main server according to claim 24, wherein the main server receives message information from the first user and selectively sends that message information to the allied user.

26. A main server according to claim 21, wherein the information sent to a first user regarding properties of the session includes information regarding other users in the session.

27. A main server according to claim 21, wherein the information sent to a first user regarding properties of the session includes information regarding the current location of the session.

28. A main server according to claim 21, wherein the information sent to a first user regarding properties of the session includes information regarding a leader of the session.
